(19) United States
(12) Patent Application Publication
(10) Pub. No.: US 2023/0165264 A1
(43) Pub. Date: Jun. 1, 2023

(54) MATERNAL MILK POWDER CONTAINING PROBIOTICS AND PREBIOTICS AND PREPARATION METHOD THEREOF

(71) Applicant: Beijing Sanyuan Foods Co., Ltd., Beijing (CN)

(72) Inventors: Lijun CHEN, Beijing (CN); Junying ZHAO, Beijing (CN); Bin LIU, Beijing (CN); Jingying DONG, Beijing (CN); Yanpin LIU, Beijing (CN); Weicang QIAO, Beijing (CN)

(21) Appl. No.: 18/156,191

(22) Filed: Jan. 18, 2023

Related U.S. Application Data
(63) Continuation of application No. PCT/CN2021/110748, filed on Aug. 5, 2021.

(30) Foreign Application Priority Data
Jul. 28, 2020 (CN) 202010738602.2

(51) Int. Cl. A23C 9/158; A23C 9/16; A23C 9/152; A23C 9/156; A23C 3/02; A23C 1/04; A23L 33/135; A23L 33/155; A23L 33/16; A23L 33/19; A23L 33/00

(52) U.S. Cl. CPC A23C 9/158; A23C 9/16; A23C 9/1522; A23C 9/156; A23C 3/02; A23C 1/04; A23L 33/135; A23L 33/155; A23L 33/16; A23L 33/19; A23L 33/40; A23Y 2220/39; A23Y 2220/73; A23Y 2220/03; A23Y 2300/55; A23Y 2300/21; A23Y 2300/25

(57) ABSTRACT

A maternal milk powder and a preparation method thereof. Every 100 g of the maternal milk powder comprises: (0.1-10)×10⁸ CFU of probiotics, 1-10 g of FOS; wherein, probiotics comprise Lactobacillus helveticus, Lactobacillus rhamnosus, Lactobacillus acidophilus, Bifidobacterium longum, Bifidobacterium animalis, and Bifidobacterium bifidum with a CFU ratio of 20-40:20-40:1-10:10-20:10-20:1-10. The maternal milk powder can effectively inhibit the proliferation of harmful bacteria in the intestinal tract of pregnant women, promote the health of intestinal microecology, improve immunity, relieve postpartum depression, etc. by adding six kinds of safe, stable and efficient probiotics and FOS.

### CROSS-REFERENCE

This disclosure claims priority of the Chinese patent application with the application number of 202010738602.2 and the invention titled “Maternal milk powder containing probiotics and prebiotics and preparation method thereof” filed in the Chinese Patent Office, and the entire content of the disclosure is incorporated herein by reference.

### FIELD OF THE INVENTION

The disclosure relates to the field of food, in particular to maternal milk powder containing probiotics and prebiotics and preparation method thereof.

### BACKGROUND

Gut microbes are the microbial flora living in the intestines of our body. These special microorganisms are very important to the body's nutrient metabolism, body development, immunity and the occurrence of various diseases. In recent years, many scientists have discovered that the intestinal flora may affect the brain structure of the body and the occurrence of many brain-related diseases through a special gut-brain axis. The probiotics have been rapidly developed and popularized in market, and they show diversity.

Existing studies have shown that the consumption of probiotics, prebiotics or products containing probiotics by pregnant and lying-in women can increase the content of probiotics and immune factors in breast milk, which further contributes to the establishment of infant gut microecology and ultimately promotes the development of the immune and metabolic system in infants.

At present, functional dairy products for pregnant and lying-in women mainly focus on supplementing nutrition during pregnancy or lactation, rather than regulating the composition of milk. Although some existing maternal milk powders contain probiotics, they are mainly Lactobacillus rhamnosus and Bifidobacterium lactis, which are beneficial for improving infant allergies, with fewer kinds (only 1-2 kinds) or very low content (10⁵ CFU/100 g). They have limited effects on pregnant and lying-in women, and it is difficult to further adjust the composition of breast milk to improve the health of offspring.

The information disclosed in the background session is only for the enhancement of understanding of the general background of the disclosure and should not be taken as an acknowledgement or any form of suggestion that the information forms the prior art already known to those ordinary skill in the art.

### SUMMARY OF THE INVENTION

### Purpose of the Invention

In order to solve the above-mentioned technical problems, the purpose of this disclosure is to provide a maternal milk powder containing probiotics and prebiotics and preparation method thereof. The maternal milk powder provided in the examples of the present disclosure synergistically promotes the maximization of the effect of probiotics on human health which can effectively inhibit the proliferation of harmful bacteria in the intestinal tract of pregnant and lying-in women, promote the health of intestinal microecology, improve immunity, relieve postpartum depression, etc. by adding six kinds of safe, stable and efficient probiotics and fructo-oligosaccharides (FOS), a prebiotic that can effectively promote the proliferation of bifidobacteria and inhibit the proliferation of harmful bacteria.

Solutions

In order to achieve the purpose of the disclosure, the examples of the disclosure provide a maternal milk powder, and every 100 g of the maternal milk powder comprises:

(0.1-10)×10⁸ CFU of probiotics, 1-10 g of fructo-oligosaccharides (FOS);
wherein the probiotics include Lactobacillus helveticus, Lactobacillus rhamnosus, Lactobacillus acidophilus, Bifidobacterium longum, Bifidobacterium animalis, and Bifidobacterium bifidum with a CFU ratio of 20-40:20-40:1-10:10-20:10-20:1-10.
CFU (colony forming units), refers to the colony formed by the reproduction of a single cell or a plurality of cells aggregated into a group on a solid medium during living bacteria count, with which to express the quantity of living bacteria.

In a possible implementation manner of the above-mentioned maternal milk powder, the CFU ratio of Lactobacillus helveticus, Lactobacillus rhamnosus, Lactobacillus acidophilus, Bifidobacterium longum, Bifidobacterium animalis, and Bifidobacterium bifidum is 30:35:5:15:10:5.

In a possible implementation manner of the above-mentioned maternal milk powder, every 100 g of the maternal milk powder comprises (0.5-5)×10⁸ CFU of probiotics; optionally, 1×10⁸ CFU of probiotics.

In a possible implementation manner of the above-mentioned maternal milk powder, every 100 g of the maternal milk powder comprises 2-5 g of FOS; optionally, 3 g of FOS.

In a possible implementation manner of the above-mentioned maternal milk powder, every 100 g of the maternal milk powder further comprises:

5-6 mg of Niacin, 950-1000 μg of Folic acid, 500-650 μg of Vitamin A, 5.0-6.0 μg of Vitamin D, 35.0-40.0 μg of Vitamin K, 0.9-1.2 mg of Vitamin B1, 30-40 mg of Docosahexaenoic acid (DHA). In a possible implementation manner of the above maternal milk powder, every 100 g of the maternal milk powder further comprises: 5.6 mg of Niacin, 986 μg of Folic acid, 600 μg of Vitamin A, 6.0 μg of Vitamin D, 40.0 μg of Vitamin K, 1 mg of Vitamin B1, 37 mg of DHA.

In a possible implementation manner of the above-mentioned maternal milk powder, every 100 g of the maternal milk powder comprises: 1×10⁸ CFU of probiotics, and 3 g of FOS; 5.6 mg of Niacin, 986 μg of Folic acid, 600 μg of Vitamin A, 6.0 μg of Vitamin D, 40.0 μg of Vitamin K, 1 mg of Vitamin B1, 37.0 mg of DHA;

Among them, the probiotics comprise Lactobacillus helveticus Rosell 52, Lactobacillus rhamnosus Rosell 11, Lactobacillus acidophilus Rosell 418, Bifidobacterium longum Rosell 175, Bifidobacterium animalis Lafti B94 and Bifidobacterium bifidum R71 with a CFU ratio of 30:35:5:15:10:5.

In a possible implementation manner of above-mentioned maternal milk powder, the total nutrition information of the maternal milk powder is as follows:

| Items | per 100 g | | NRV % |
|---|---|---|---|
| Energy | 1822 | kJ | 21% |
| Protein | 23.0 | g | 38% |
| Fat | 13.8 | g | 23% |
| Carbohydrate | 52.7 | g | 16% |
| Fiber (as FOS + Inulin) | 3.0 | g | 24% |
| Sodium | 300 | mg | 18% |
| Vitamin A | 600 | μg of retinol | 75% |
| | | equivalent | |
| Vitamin D | 6.0 | μg | 120% |
| Vitamin E | 9.60 | mg of α -tocopherol | 68% |
| | | equivalent | |
| Vitamin K | 40.0 | μg | 50% |
| Vitamin B1 | 1.00 | mg | 71% |
| Vitamin B2 | 1.50 | mg | 107% |
| Vitamin B6 | 1.20 | mg | 86% |
| Vitamin B12 | 2.50 | μg | 104% |
| Vitamin C | 90.0 | mg | 90% |
| Niacin (Niacinamide) | 5.6 | mg | 40% |
| Folic acid | 986 | μg of folic acid | 247% |
| | | equivalent | |
| Pantothenic acid | 6.00 | mg | 120% |
| Choline | 255.0 | mg | 57% |
| Phosphorus | 500 | mg | 71% |
| Potassium | 700 | mg | 35% |
| Magnesium | 60 | mg | 20% |
| Calcium | 1000 | mg | 125% |
| Iron | 20.0 | mg | 133% |
| Zinc | 8.50 | mg | 57% |
| DHA | 37.0 | mg | |
| Bifidobacterium bifidum, | 1 × 10⁸ | CFU | |
| Lactobacillus helveticus, | | | |
| Lactobacillus rhamnosus, | | | |
| Lactobacillus acidophilus, | | | |
| Bifidobacterium longum, | | | |
| Bifidobacterium animalis | | | |

The examples of the present disclosure also provide a method for preparing the above-mentioned maternal milk powder, the preparation method comprising the following steps:

Pre-sterilizing, checking and accepting the raw milk; feeding according to the above formula, adding all ingredients except probiotics when feeding; homogenizing by using a homogenizer at a homogenization pressure of 4-18 Mpa; sterilizing and concentrating at 85-97° C.; spray-drying to obtain powder; adding probiotics to the resulting powder and mixing. The milk powder is produced by wet process, and probiotics are added by dry mixing to ensure the maximum the uniformity of mixing and retention of nutrients.

The testing of nutrition indicators, physical and chemical indicators, microbial indicators and sensory indicators of products is carried out in accordance with the testing items and testing methods specified in the National Food Safety Standard Nutritional Supplements for Pregnant Women and Lactating Mothers (GB 31601-2015).

Beneficial Effects

(1) The maternal milk powder provided in the examples of the present disclosure synergistically promotes the maximization of the effect of probiotics on human health which can effectively inhibit the proliferation of harmful bacteria in the intestinal tract of pregnant and lying-in women, promote the health of intestinal microecology, improve immunity, relieve postpartum depression, etc. by adding six kinds of safe, stable and efficient probiotics and FOS, a prebiotic that can effectively promote the proliferation of bifidobacteria and inhibit the proliferation of harmful bacteria. A certain amount of 6 kinds of probiotics added in the disclosure act synergistically with each other, can more effectively inhibit harmful bacterial infection, promote intestinal microecological health, improve immunity, relieve postpartum depression, relieve constipation and the like.

Among them, Bifidobacterium bifidum can significantly relieve constipation. Lactobacillus helveticus and Lactobacillus rhamnosus can produce exopolysaccharides to reduce oxidative stress, adhesion and barrier effects, and improve the adhesion of human intestinal epithelial cells IEC, and inhibit pathogenic bacteria such as Salmonella typhimurium, Escherichia coli, Campylobacter jejuni, Staphylococcus aureus and other harmful bacteria, and have immunomodulatory effects to increase IgM, IgG content. Lactobacillus acidophilus is antibacterial and prevents yeast or bacterial infections, and Lactobacillus acidophilus may help lactose intolerant subjects digest lactose, it also has immunomodulatory effects to normalize abnormal immune parameters, and can treat inflammatory bowel disease. Bifidobacterium longum can improve general anxiety and depression, especially somatic symptoms, depression and irritability. Bifidobacterium animalis modulates inflammatory responses, reduces allergic responses, reduces IgE and circulating eosinophils; it has immune-supporting effects to increase interleukin-12 levels, promotes immune responses, stimulates T-cell growth and function, and increases interferon production.

(2) In the maternal milk powder provided in the examples of the disclosure, the added FOS can be used as food for intestinal probiotics to promote the proliferation of intestinal probiotics. After adding FOS and six kinds of probiotics simultaneously, it can help pregnant and lying-in women to establish the intestinal flora with probiotics as the dominant flora, thereby maintaining the health and stability of the intestinal flora.
(3) For the maternal milk powder in the examples of the disclosure, the proportions of six kinds of probiotics are further selected, and within the range of proportions provided in this disclosure, the six kinds of probiotics can play a better role.
(4) For the maternal milk powder provided in the examples of this disclosure, it is formulated with six kinds of probiotics and prebiotics FOS. The maternal milk powder is controlled to comprise certain contents of niacin, folic acid, vitaminA, vitaminD, vitaminK, vitaminB1 and DHA, the nutrition is more balanced, which can better play the health care effect of maternal milk powder.
(5) In the preparation method of the maternal milk powder provided in the examples of this disclosure, the addition of probiotics is carried out by dry mixing, and the milk powder production is carried out by wet process, so as to ensure the uniformity of mixing and the retention of nutrients to the maximum extent.

### DETAILED DESCRIPTION OF THE INVENTION

In order to make the purposes, technical solutions and advantages of the examples of the present disclosure clearer, the technical solutions in the examples of the present disclosure will be described clearly and completely below. Obviously, the described examples are part of the examples of the present disclosure, not all examples. Based on the examples in the disclosure, all other examples obtained by those ordinary skill in the art without inventive efforts fall within the scope of protection of the disclosure. Unless otherwise stated, throughout the description and claims, the term “include”, “including” or its conjugations such as “comprising”, “comprising” or “consist of”, “consisting of” and the like will be understood to include the stated elements or components, and other elements or components are not excluded.

In addition, in order to better illustrate the present disclosure, numerous specific details are given in the detailed embodiment. It should be understood by those skilled in the art that the present disclosure may be practiced without certain specific details. In some examples, materials, elements, methods, means, etc. that are well known to those skilled in the art are not described in detail, so as to highlight the subject of the present disclosure.

In the following examples, the probiotic strains used, Lactobacillus helveticus Rosell 52, Lactobacillus rhamnosus Rosell 11, Lactobacillus acidophilus Rosell 418, Bifidobacterium longum Rosell 175, Bifidobacterium animalis Lafti B94 and Bifidobacterium bifidum R71 are all commercially available products.

### Example 1

1. A maternal milk powder containing probiotics and prebiotics, each 100 g of the maternal milk powder comprises: 1×10⁸ CFU of probiotics, 3 g of FOS; 5.6 mg of Niacin, 986 μg of Folic Acid, 600 μg of Vitamin A, 6.0 μg of Vitamin D, 40.0 μg of Vitamin K, 1 mg of Vitamin B1, 37.0 mg of DHA; wherein, the probiotics include Lactobacillus helveticus Rosell 52, Lactobacillus rhamnosus Rosell 11, Lactobacillus acidophilus Rosell 418, Bifidobacterium longum Rosell 175, Bifidobacterium Lafti B94 and Bifidobacterium bifidum R71 with a CFU ratio of 30:35:5:15:10:5.
2. Preparation method of above-mentioned maternal milk powder comprises the steps below: Select qualified suppliers to determine the source of raw milk, then check and accept; After purifying the milk, put all the ingredients except probiotics according to the above formula, use a homogenizer to homogenize, and the homogenization pressure is 15 Mpa to break the large fat balls; Sterilize at 90° C., concentrate to the specified concentration; Pump into a spray tower by a high-pressure pump (210-230 bar) and evaporate and dry into a uniform powder in the tower; Add probiotics, mix and pack into finished product.

Nutrition information of the above-mentioned maternal milk powder is shown in Table 1.

TABLE 1

| Items | per 100 g | | NRV % |
|---|---|---|---|
| Energy | 1822 | kJ | 21% |
| Protein | 23.0 | g | 38% |
| Fat | 13.8 | g | 23% |
| Carbohydrate | 52.7 | g | 16% |
| Fiber (as FOS + Inulin) | 3.0 | g | 24% |
| Sodium | 300 | mg | 18% |
| Vitamin A | 600 | μg of retinol | 75% |
| | | equivalent | |
| Vitamin D | 6.0 | μg | 120% |
| Vitamin E | 9.60 | mg of α -tocopherol | 68% |
| | | equivalent | |
| Vitamin K | 40.0 | μg | 50% |
| Vitamin B1 | 1.00 | mg | 71% |
| Vitamin B2 | 1.50 | mg | 107% |
| Vitamin B6 | 1.20 | mg | 86% |
| Vitamin B12 | 2.50 | μg | 104% |
| Vitamin C | 90.0 | mg | 90% |
| Niacin (Niacinamide) | 5.6 | mg | 40% |
| Folic acid | 986 | μg of folic acid | 247% |
| | | equivalent | |
| Pantothenic acid | 6.00 | mg | 120% |
| Choline | 255.0 | mg | 57% |
| Phosphorus | 500 | mg | 71% |
| Potassium | 700 | mg | 35% |
| Magnesium | 60 | mg | 20% |
| Calcium | 1000 | mg | 125% |
| Iron | 20.0 | mg | 133% |
| Zinc | 8.50 | mg | 57% |
| DHA | 37.0 | mg | |
| Bifidobacterium bifidum, | 1 × 10⁸ | CFU | |
| Lactobacillus helveticus, | | | |
| Lactobacillus rhamnosus, | | | |
| Lactobacillus acidophilus, | | | |
| Bifidobacterium longum, | | | |
| Bifidobacterium animalis | | | |

### 3. Safety Inspection

The above-mentioned maternal milk powder was entrusted to the Beijing Haidian District Product Quality Supervision and Inspection Institute to conduct item-by-item inspections in accordance with the requirements of the National Food Safety Standard for Nutritional Supplements for Pregnant Women and Lactating Mothers (GB 31601-2015).

The above-mentioned maternal milk powder was tested for probiotics, and the results are shown in Table 2.

TABLE 2

| Inspection | | |
|---|---|---|
| items | Measured value | Inspection basis |
| Total number | 25; <10; 50; <10; | GB4789.2-2016 National Food |
| of colonies, | <10 | Safety Standard Food |
| CFU/g | | Microbiological Inspection |
| | | Determination of Total Colony |
| Lactobacillus, | 9.4 × 10⁷ | GB4789.35-2016 National Food |
| CFU/g | | Safety Standard Food |
| | | Microbiological Inspection |
| | | Lactic Acid Bacteria Inspection |
| Bifidobacterium, | 4.8 × 10⁷ | GB4789.35-2016 National Food |
| CFU/g | | Safety Standard Food |
| | | Microbiological Inspection |
| | | Lactic Acid Bacteria Inspection |

### Example 2

1. A maternal milk powder containing probiotics and prebiotics, every 100 g of the maternal milk powder comprises: 0.5×10⁸ CFU of probiotics, and 2 g of FOS; 5.0 mg of Niacin, 950 μg of Folic Acid, 500 μs of Vitamin A, 5.0 μs of Vitamin D, 35.0 μs of Vitamin K, 0.9 mg of Vitamin B1, 30.0 mg of DHA; wherein the probiotics comprise Lactobacillus helveticus Rosell 52, Lactobacillus rhamnosus Rosell 11, Lactobacillus acidophilus Rosell 418, Bifidobacterium longum Rosell 175, Bifidobacterium animalis Lafti B94 and Bifidobacterium bifidum R71 with a CFU ratio of 20:20:1:10:10:1.
2. The preparation method of the above-mentioned maternal milk powder is the same as in Example 1.

### Example 3

1. A maternal milk powder containing probiotics and prebiotics, each 100 g of the maternal milk powder comprises: 5×10⁸ CFU of probiotics, 5 g of FOS; 6.0 mg of Niacin, 1000 μs of Folic Acid, 650 μs of Vitamin A, 6.0 μs of Vitamin D, 40.0 μs of Vitamin K, 1.2 mg of Vitamin B1, 40.0 mg of DHA; wherein, the probiotics comprise Lactobacillus helveticus Rosell 52, Lactobacillus rhamnosus Rosell 11, Lactobacillus acidophilus Rosell 418, Bifidobacterium longum Rosell 175, Bifidobacterium animalis Lafti B94 and Bifidobacterium bifidum R71 with a CFU ratio of 40:40:10:20:20:10.
2. The preparation method of the above-mentioned maternal milk powder is the same as in Example 1.

Compared with the existing milk powder, the maternal milk powder provided by the examples of the present disclosure contains six specific probiotics and FOS prebiotics, which can better inhibit the proliferation of harmful bacteria, promote the health of intestinal microecology, improve immunity, and relieve postpartum depression, etc.

Finally, it should be noted that the above embodiments are only used to illustrate the technical solutions of the present disclosure, rather than to limit them. Although the present disclosure has been described in detail with reference to the foregoing examples, those ordinary skill in the art should understand that: it is still possible to modify the technical solutions recorded in the foregoing examples or perform equivalent replacements to some of the technical features. These modifications or substitutions do not make the essence of the corresponding technical solutions deviate from the spirit and scope of the technical solutions of the embodiments of the present disclosure.

### INDUSTRIAL APPLICABILITY

A maternal milk powder containing probiotics and prebiotics and a preparation method thereof provided in the examples of the disclosure, wherein, every 100 g of the maternal milk powder comprises: (0.1-10)×10⁸ CFU of probiotics, 1-10 g of FOS. The disclosure synergistically promotes the maximization of the effect of probiotics on human health, effectively inhibit the proliferation of harmful bacteria in the intestinal tract of pregnant and lying-in women, promote the health of intestinal microecology, improve immunity, relieve postpartum depression, etc. by adding six kinds of safe, stable and efficient probiotics and FOS, a prebiotic that can effectively promote the proliferation of bifidobacteria and inhibit the proliferation of harmful bacteria.

1. A maternal milk powder, wherein every 100 g of the maternal milk powder comprises: (0.1-10)×10⁸ CFU of probiotics, 1-10 g of fructo-oligosaccharides;
wherein the probiotics comprise Lactobacillus helveticus, Lactobacillus rhamnosus, Lactobacillus acidophilus, Bifidobacterium longum, Bifidobacterium animalis, and Bifidobacterium bifidum with a CFU ratio of 20-40:20-40:1-10:10-20:10-20:1-10.

2. The maternal milk powder according to claim 1, wherein the CFU ratio of Lactobacillus helveticus, Lactobacillus rhamnosus, Lactobacillus acidophilus, Bifidobacterium longum, Bifidobacterium animalis and Bifidobacterium bifidum is 30:35:5:15:10:5.

3. The maternal milk powder according to claim 1, wherein every 100 g of the maternal milk powder comprises (0.5-5)×10⁸ CFU of probiotics.

4. The maternal milk powder according to claim 1, wherein every 100 g of the maternal milk powder comprises 1×10⁸ CFU of probiotics.

5. The maternal milk powder according to claim 4, wherein every 100 g of the maternal milk powder comprises 2-5 g of fructo-oligosaccharides; optionally, comprises 3 g of fructo-oligosaccharides.

6. The maternal milk powder according to claim 5, wherein every 100 g of the maternal milk powder also comprises:
5-6 mg of Niacin, 950-1000 μg of Folic Acid, 500-650 μg of Vitamin A, 5.0-6.0 μg of Vitamin D, 35.0-40.0 μg of Vitamin K, 0.9-1.2 mg of Vitamin B1, 30-40 mg of DHA.

7. The maternal milk powder according to claim 6, wherein every 100 g of the maternal milk powder, also comprises: 5.6 mg of Niacin, 986 μg of Folic acid, 600 μg of Vitamin A, 6.0 μg of Vitamin D, 40.0 μg of Vitamin K, 1 mg of Vitamin B1, 37 mg of DHA.

8. The maternal milk powder according to claim 7, wherein every 100 g of the maternal milk powder comprises: 1×10⁸ CFU of probiotics, 3 g of fructo-oligosaccharides; 5.6 mg of Niacin, 986 μg of Folic Acid, 600 μg of Vitamin A, 6.0 μg of Vitamin D, 40.0 μg g of Vitamin K, 1 mg of Vitamin B1, 37.0 mg of DHA;
wherein, the probiotics comprise Lactobacillus helveticus Rosell 52, Lactobacillus rhamnosus Rosell 11, Lactobacillus acidophilus Rosell 418, Bifidobacterium longum Rosell 175, Bifidobacterium animalis Lafti B94 and Bifidobacterium bifidum R71 with a CFU ratio of 30:35:5:15:10:5.

9. The maternal milk powder according to claim 6, wherein total nutrition information of the maternal milk powder is as follows:

| Items | per 100 g | | NRV % |
|---|---|---|---|
| Energy | 1822 | kJ | 21% |
| Protein | 23.0 | g | 38% |
| Fat | 13.8 | g | 23% |
| Carbohydrate | 52.7 | g | 16% |
| Fiber (as fructo- | 3.0 | g | 24% |
| oligosaccharides + Inulin) | | | |
| Sodium | 300 | mg | 18% |
| Vitamin A | 600 | μg of retinol | 75% |
| | | equivalent | |
| Vitamin D | 6.0 | μg | 120% |
| Vitamin E | 9.60 | mg of α -tocopherol | 68% |
| | | equivalent | |
| Vitamin K | 40.0 | μg | 50% |
| Vitamin B1 | 1.00 | mg | 71% |
| Vitamin B2 | 1.50 | mg | 107% |
| Vitamin B6 | 1.20 | mg | 86% |
| Vitamin B12 | 2.50 | μg | 104% |
| Vitamin C | 90.0 | mg | 90% |
| Niacin (Niacinamide) | 5.6 | mg | 40% |
| Folic acid | 986 | μg of folic acid | 247% |
| | | equivalent | |
| Pantothenic acid | 6.00 | mg | 120% |
| Choline | 255.0 | mg | 57% |
| Phosphorus | 500 | mg | 71% |
| Potassium | 700 | mg | 35% |
| Magnesium | 60 | mg | 20% |
| Calcium | 1000 | mg | 125% |
| Iron | 20.0 | mg | 133% |
| Zinc | 8.50 | mg | 57% |
| DHA | 37.0 | mg | |
| Bifidobacterium bifidum, | 1 × 10⁸ | CFU | |
| Lactobacillus helveticus, | | | |
| Lactobacillus rhamnosus, | | | |
| Lactobacillus acidophilus, | | | |
| Bifidobacterium longum, | | | |
| Bifidobacterium animalis | | | |

10. A method for preparing the maternal milk powder according to claim 1, wherein the method comprises following steps:
Pre-sterilizing, checking and accepting the raw milk; feeding according to the formula of claim 1, adding all ingredients except probiotics when feeding; homogenizing by using a homogenizer at a homogenization pressure of 4-18 Mpa; sterilizing and concentrating at 85-97° C.; spray-drying to obtain powder; adding probiotics to the resulting powder and mixing.
